(19) United States
(12) Patent Application Publication
(10) Pub. No.: US 2006/0251337 A1
(43) Pub. Date: Nov. 9, 2006

(54) Image object processing

(76) Inventors: Peter Andre Redert, Eindhoven (NL); Christiaan Varekamp, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/567,219

(22) PCT Filed: Aug. 2, 2004
(86) PCT No.: PCT/IB04/51362

§ 371 Date: Feb. 3, 2006

(30) Foreign Application Priority Data
Sep. 7, 2003 (EP) 03102465.6

(51) Int. Cl. G06K 9/36

(52) U.S. Cl. 382/285

(57) ABSTRACT

An apparatus (200) comprises a simple detector (201) for detecting a plurality of image points (105, 107, 109, 111) associated with at least one object of the at least one image. The detector does not differentiate between different types of image points. The detector (201) is coupled to a grouping processor (203) which groups the plurality of image points (105, 107, 109, 111) into a group of object points (105, 107), a group of junction points (111) and a group of falsely detected points (109). The apparatus further comprises a processor arrangement 209 for individually processing the image points of the group of object points (105, 107) and the group of junction points (111). The object point process may generate depth information based on dynamic characteristics and the junction point process may generate depth information based on static characteristics. Improved depth information may thus be achieved and a simplified detector may be employed.

### FIELD OF THE INVENTION

The invention relates to a method and apparatus for object processing for at least one image.

### BACKGROUND OF THE INVENTION

Conventional video and TV systems distribute video signals which inherently are two dimensional (2D) in nature. However, it would in many applications be desirable to further provide three dimensional (3D) information. For example, 3D information may be used for enhancing object grasping and video compression for video signals.

In particular three dimensional video or television (3DTV) is promising as a means for enhancing the user experience of the presentation of visual content, and 3DTV could potentially be as significant as the introduction of colour TV.

The most commercially interesting 3DTV systems are based on re-use of existing 2D video infrastructure thereby allowing for a minimal cost and compatibility problems associated with a gradual roll out. For these systems, 2D video is distributed and is converted to 3D video at the location of the consumer.

The 2D-to-3D conversion process adds (depth) structure to 2D video and may also be used for video compression. However, the conversion of 2D video into video comprising 3D information is a major image processing challenge. Consequently, significant research has been undertaking in this area and a number of algorithms and approaches have been suggested for extracting 3D information from 2D images.

Known methods for deriving depth or occlusion relations from monoscopic video comprise the structure from motion approach and the dynamic occlusion approach.

In the structure from motion approach, points of an object are tracked as the object moves and are used to derive a 3D model of the object. The 3D model is determined as that which would most closely result in the observed movement of the tracked points. The dynamic occlusion approach utilises the fact that as different objects move within the picture, the occlusion (i.e. the overlap of one object over another in a 2D picture) provides information indicative of the relative depth of the objects.

However, structure from motion requires the presence of camera motion and cannot deal with independently moving objects (non-static scene). Furthermore, both approaches rely on the existence of moving objects and fail in situations where there is very little or no apparent motion in the video sequence.

Methods for deriving depth information based on static characteristics have been suggested.

A depth cue which may provide static information is a T-junction corresponding to an intersection between objects. However, although the possibility of using T-junctions as a depth cue for vision has been known for a long time, computational methods for detecting T-junctions in video and use of T-junctions for automatic depth extraction have had very limited success so far.

Previous research into the use of T-junction has mainly focussed on the T-junction detection task and example of schemes for detecting T-junctions are given in “Filtering, Segmentation and Depth” by M. Nitzberg, D. Mumford and T. Shiota, 1991. Lecture Notes in Computer Science 662. Springer-Verlag, Berlin; “Steerable-scalable kernels for edge detection and junction analysis” by P. Perona, 1992. 2nd European Conference of Computer Vision pages 3-18 Image and Vision Computing, vol. 10, pag. 663-672 and “Junctions: Detection, Classification, and Reconstruction”, L. Parida, D. Geiger, R. Hummel, 1998 IEEE Transactions on Pattern Analysis and Machine Intelligence, vol. 20, no. 7, pp. 687-698.

Furthermore, the document “Filtering, Segmentation and Depth” by M. Nitzberg, D. Mumford and T. Shiota discloses a system for determining depth information based on T-junctions. This approach is based on determination of contours and require non-linear filtering, curve smoothing, corner and junction detection and curve continuation. Hence, the described method is very complex and requires significant computational resource but does provide for extraction of depth information from static characteristics.

However, although significant research has been undertaking in the field of object processing for depth information, the accuracy and reliability of the extracted depth information is currently not as good as desired.

Furthermore, as the individual processes rely on detection of specific features of an image (e.g. T-junctions or corner points of an object), the accurate and reliable detection of these features is critical and is furthermore computationally demanding.

Hence, an improved system for object processing for at least one image would be advantageous and in particular a system for object processing for depth information allowing for reduced complexity, reduced computational burden and/or improved performance would be advantageous.

### SUMMARY OF THE INVENTION

Accordingly, the Invention preferably seeks to mitigate, alleviate or eliminate one or more of the above mentioned disadvantages singly or in any combination.

The inventors of the current invention have realised that improved performance in object processing and in particular object processing for depth information may be achieved by combining different processes and in particular by combining processes based on dynamic characteristics with processes based on static characteristics. Furthermore, the inventors have realised that these processes may be based on different features of the image for optimal performance.

Accordingly there is provided according to a first aspect of the invention, a method of object processing for at least one image comprising the steps of: detecting a plurality of image points associated with at least one object of the at least one image; grouping the plurality of image points into at least a group of object points and a group of junction points; and individually processing the image points of the group of object points and the group of junction points.

The invention allows for detected image points being grouped according to whether they are object points or junction points. Object points may be advantageously used for determining depth information based on dynamic characteristics and junction points may advantageously be used for determining depth information based on static characteristics. Thus, the invention allows for image points of one or more images to be separated into different groups which may then be individually processed. Thus the invention allows for improved performance as object processes may be supplied with the optimal image points for the specific process. Furthermore, improved performance may be achieved as object points and junction points are separated thereby reducing the probability that object points are fed to a process requiring junction points and vice versa. The invention furthermore allows for a simple detection process to be used for detecting image points rather than complex dedicated processes for detecting only object points and junction points. The simple detection may be followed by a simple process which determines whether a given image point is more likely to be an object point or a junction point. Thus, detection processes may be re-used for different types of image points thereby resulting in reduced complexity and reduced computational requirements.

An object point may typically be a feature of a single object in the image, such as a corner or side of the object whereas a junction point typically refers to a relative feature between two or more objects, such as an intersection point between two objects wherein one occludes the other.

According to a feature of the invention, the step of individually processing comprises determining at least one three dimensional characteristic from at least one two dimensional image. Hence, the invention allows for an improved process of determining 3D characteristics from one or more 2D images. Specifically, the invention allows for an improved and low complexity method for determining depth information which may preferably combine relative and absolute depth information determined in response to static and dynamic characteristics respectively.

According to another feature of the invention, the plurality of image points is further grouped into a group of falsely detected points. This allows for improved performance of the individual processing of the image points as the probability of including falsely detected points in the processing is reduced.

According to another feature of the invention, each of the plurality of image points is included in only one group selected from the group of object points, the group of junction points and the group of falsely detected points.

Preferably, each point which has been detected is identified as either an object point or a junction point or a falsely detected point. The individual processing may be improved as this may result in an increased probability that the processing is based only on points of the appropriate type. For example, applying an object point identification routine to a point may result in an indication that the image point has a probability above 0.5 of it being an object point. However, applying a junction point identification routine to the same image point may also result in an indication that the image point has a probability above 0.5 of it being a junction point. Therefore, using these routines independently may result in the image point being used both for object point processing and junction point processing. However, by only allocating the image point to the group that it most likely corresponds to, the probability of it being included in the wrong group is reduced. For example, the junction point identification routine may provide a probability of 0.95 and the object point identification routine may provide a probability of 0.5 in which case the image point may be added to the group of junction points.

According to another feature of the invention, the step of individually processing comprises applying a first process to the group of object points and applying a second process to the group of junction points. Preferably different processes are applied to the object points and the junction points. Thus, the first process may be based on or particularly suited for processing object points whereas the second process may be based on or particularly suited for processing junction points. The first and second process may be completely separate. Furthermore, the results of the first and second process may be combined to provide improved results over that which can be achieved from each individual process.

According to another feature of the invention, the first process is an object process based on object motion within the at least one image. Object points are particularly well suited for processes based on object motion. Specifically, object points are suitable for determining or processing the movements of an object and particularly movements of a 3D object in a 2D image. Hence improved performance of an object process based on object motion may be achieved. The first process may for example be a process for object identification, object tracking or depth detection. As a specific example, the first process may be a dynamic occlusion depth detection process.

According to another feature of the invention, the first process is a structure from motion process. Hence, the invention may allow for improved 3D structure information to be derived from object motion determined from object points.

According to another feature of the invention, the second process is an object process based on a static characteristic within the at least one image. Junction points are particularly well suited for determining static characteristics. The second process may for example be an object identification process.

According to another feature of the invention, the second process is a process for determining a depth characteristic of at least one object of the at least one image. Junction points are particularly well suited for processes determining depth information based on static characteristics and specifically relative depth information between different objects may be determined. Thus improved performance of an object process determining depth information may be achieved.

Preferably the first process is a process for determining depth information in response to dynamic characteristics associated with the object points and the second process is a process for determining depth information in response to static characteristics associated with the junction points. The depth information derived by the first and second processes is preferably combined thereby providing additional and/or more accurate and/or reliable depth information.

According to another feature of the invention, the depth characteristic is a relative depth characteristic indicating a relative depth between a plurality of objects of the at least one image. Junction points are particularly suitable for determining relative depth information.

According to another feature of the invention, the step of detecting the plurality of image points comprises applying a curvature detection process to at least a part of the at least one image. A curvature detection process is a particularly simple and effective process for detecting image points but does not differentiate between the different types of image points. Hence, the invention allows for a low complexity, easy to implement detection process having low computational resource requirement to be used while providing good performance.

Preferably the junction points comprise T-junction points corresponding to an overlap between two objects of the at least one image.

According to a second aspect of the invention, there is provided an apparatus for object processing for at least one image comprising: means for detecting a plurality of image points associated with at least one object of the at least one image; means for grouping the plurality of image points into at least a group of object points and a group of junction points; and means for individually processing the image points of the group of object points and the group of junction points.

These and other aspects, features and advantages of the invention will be apparent from and elucidated with reference to the embodiment(s) described hereinafter.

### BRIEF DESCRIPTION OF THE DRAWINGS

An embodiment of the invention will be described, by way of example only, with reference to the drawings, in which

FIG. 1 illustrates an example of a 2D image comprising two objects;

FIG. 2 illustrates an apparatus for object processing of one or more images in accordance with a preferred embodiment of the invention;

FIG. 3 illustrates a flow chart of a method of object processing in accordance with an embodiment of the invention; and

FIG. 4 illustrates an example of a T-junction in an image

### DESCRIPTION OF PREFERRED EMBODIMENTS

The following description focuses on an embodiment of the invention applicable to object processes for determining depth information from a two-dimensional image. However, it will be appreciated that the invention is not limited to this application but may be applied to many other object processes including object detection or object imaging processes.

The possibility of extracting depth information from two dimensional images (including images of video sequences) is attracting increasing attention and promises to provide enhanced functionality of image applications as well as enabling new applications. For example, extraction of depth information may enable three dimensional video images to be generated from conventional two dimensional video.

Typically methods for extracting depth information comprise detecting depth information in response to movement of objects within images. Thus object points corresponding to specific points of an object are tracked between images and these object points are used to determine a 3D model of the object. One such method determines structure from motion of an object.

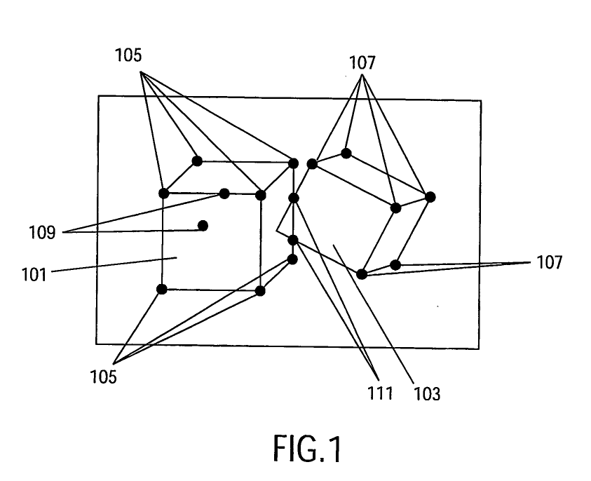

FIG. 1 illustrates an example of a 2d image comprising two objects. Specifically, the image comprises a first cube 101 and a second cube 103. In the structure from motion process, first object points 105 corresponding to the corners of the first cube 101 are used to determine a 3D model of the first cube 101. Similarly, second object points 107 corresponding to the corners of the second cube 103 are used to determine a 3D model of the second cube 103. Parameters of the 3D models are determined such that the corner points when projected on to a 2D representation perform the movement observed of the corner points in the 2D image.

Thus, processes such as the structure from motion process require that corner points of objects are detected. An example of a detector which may be used for detection of object corners is given in M. Pollefeys, R. Koch, M. Vergauwen and L. van Gool, “Flexible acquisition of 3D structure from motion”, Proc. IEEE IMDSP Workshop, pp. 195-198, 1998. This detector, as most other known detectors, relies explicitly or implicitly on detecting corner points based on curvature properties, i.e. on abrupt variations in a parameter such as brightness or colour.

A disadvantage of these detectors is that they not only detect corner points but also detect many other image points. For example, the detectors may falsely detect points 109 which do not correspond to a corner of an object but which coincidentally have properties which meet the detector criteria. Furthermore, other points such as junction points and specifically T-junction points 111 may also show abrupt changes in image parameters and accordingly be detected by the corner detector. However, for processes such as the structure from motion, it is essential that only real fixed object points are used to determine the 3D model. For example, considering the falsely detected points 109 or the junction points 111 as corner points will distort the 3D model that can be derived (or prevent one from being derived).

Accordingly it may be necessary to use a significantly more complex detector which has significantly reduced probability of detecting unwanted image points. However, this requires very complex processing and results in an increased computational burden.

Alternatively or additionally, the valid object points must be extracted from the detected image points. This may be achieved by deriving 3D models wherein image points that do not fit in are discarded. However, this is not only a very complex process but also has a high probability of erroneously discarding valid object points or included unwanted object points.

The inventors of the current invention have realised that rather than simply extracting object points (such as corner points), improved performance may be derived by dividing image points detected by an image point detector into groups of image points of different categories. Specifically, the inventors have realised that junction points may be individually processed and may advantageously be used to derive depth information improving or supplementing the depth information derived from the object points.

The inventors have realised that dividing the detected image points into at least a group of junction points and a group of object points will facilitate the detection process and allow for a simple common detection algorithm to be used both for detection of image points for an object point process and for a junction point process. Hence, a simplified detection is achieved with reduced complexity and computational burden. In addition, improved performance may be achieved of the individual processes as the probability of unwanted image points erroneously being used in a given process is desired. Specifically, it is typically more reliable to detect whether an image point is more likely to be an object point or a junction point than it is to determine whether a given point is an object point or not. Furthermore, the inventors have realised that rather than discarding the junction points these may be processed independently and the results possibly combined with those resulting from the object point process thereby improving the overall performance of a depth information processing.

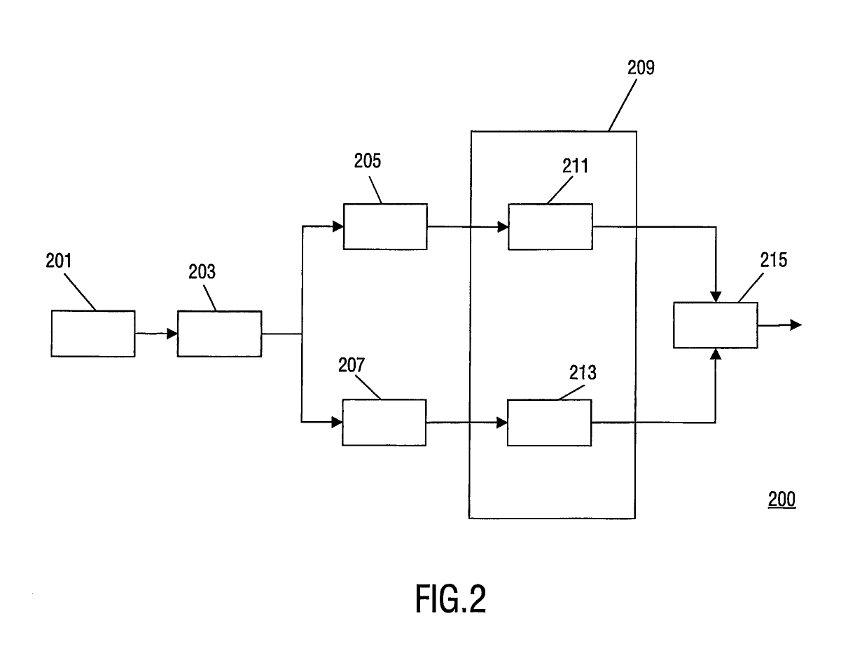

FIG. 2 illustrates an apparatus 200 for object processing of one or preferably more images in accordance with a preferred embodiment of the invention.

The apparatus comprises a detector 201 which receives images and performs an image detection process which detects both object points and junction points. Thus, the detector 201 detects a plurality of image points associated with at least one object of the image(s). For example, an arbitrary curvature detector that finds both object points and T-junctions without discriminating between these may be used.

The detector 201 is coupled to a grouping processor 203 which is operable to group the plurality of image points into at least a group of object points and a group of junction points. In the preferred embodiment, the image points may further be grouped into a group of falsely detected points i.e. image points which are considered to be neither object points nor junction points.

The grouping processor 203 is coupled to an object point store 205 wherein the detected object points are stored and a junction point store 207 wherein the detected junction points are stored. The falsely detected points are simply discarded.

The object point store 205 and junction point store 207 are connected to a processor arrangement 209 which is operable to individually process the image points of the group of object points and the group of junction points. In the preferred embodiment, the processor arrangement 209 comprises an object point processor 211 coupled to the object point store 205 and operable to process the stored object points. Specifically, the object point processor 211 may perform a depth information process such as the structure from motion process. The processor arrangement 209 further comprises a junction point processor 213 coupled to the junction point store 207 and operable to process the stored junction points. Specifically, the junction point processor 213 may perform a depth information process based on T-junctions.

The object point processor 211 and junction point processor 213 are in the preferred embodiment coupled to a combine processor 215 which combines the depth information generated by the individual processes. For example, a depth map for the image may be generated wherein the relative depth relationships between objects are determined predominantly on the basis of the information from the junction point processor 213 whereas depth characteristics of the individual object is determined predominantly on the basis of the information from the object point processor 211.

It will be appreciated that although the above description for clarity has referred to different processors these should only be considered as functional modules rather than as physical entities. Thus, the different processes may for example in the preferred embodiment be performed by a single digital signal processor.

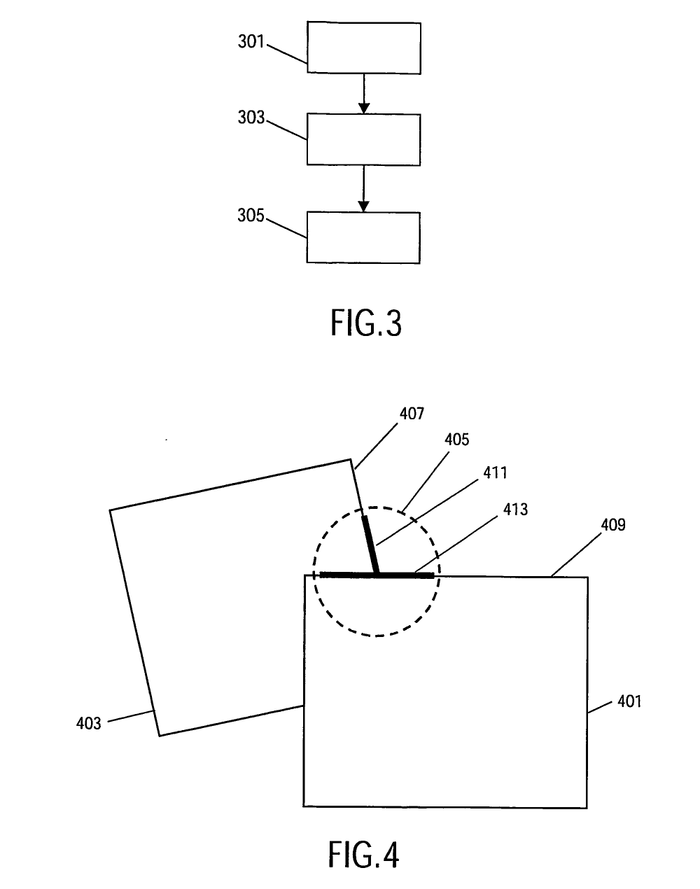

FIG. 3 illustrates a flow chart of a method of object processing in accordance with a preferred embodiment of the invention.

The method initiates in step 301 wherein a plurality of image points associated with at least one object of the at least one image is detected. In the preferred embodiment, a curvature detection process is applied to the whole or to at least a part of one or more images.

For example, the detection algorithm described in M. Pollefeys, R. Koch, M. Vergauwen and L. van Gool, “Flexible acquisition of 3D structure from motion”, Proc. IEEE IMDSP Workshop, pp. 195-198, 1998 may be used. Alternatively or additionally, a detection based on segmentation of an image may be used.

Step 301 is followed by step 303 wherein the plurality of image points are grouped into at least a group of object points and a group of junction points and preferably into a group of falsely detected points. In the preferred embodiment, each of the plurality of image points is included in only one group selected from the group of object points, the group of junction points and the group of falsely detected points. Thus in step 303, each of the detected image points is evaluated and put into one and only one group. In other words, each image point us characterized as either an object point or a junction point or a falsely detected point

Furthermore, the object points are grouped into sets of object points belonging to an individual object. Specifically, the grouping of image points into object points and the grouping into sets corresponding to each object may be done using the process described in D. P. McReynolds and D. G. Lowe, “Rigidity checking of 3D point correspondences under perspective projection”, IEEE Trans. on PAMI, Vol. 18, No. 12, pp. 1174-1185, 1996.

In this case, the grouping is based on the fact that all points belonging to one moving rigid object will follow the same 3D motion model. Thus, junction points and falsely detected points which do not follow any motion model are not considered object points.

The remaining points are subsequently processed to extract junctions. As a specific example, the image may be divided into a number of segments corresponding to disjoint regions of the image. The aim of image segmentation is to group pixels together into image segments which are unlikely to contain depth discontinuities. A basic assumption is that a depth discontinuity causes a sharp change of brightness or colour in the image. Pixels with similar brightness and/or colour are therefore grouped together resulting in brightness/colour edges between regions.

In one embodiment the segmentation comprises grouping picture elements having similar brightness levels in the same image segment. Contiguous groups of picture elements having similar brightness levels tend to belong to the same underlying object. Similarly, contiguous groups of picture elements having similar colour levels also tend to belong to the same underlying object and the segmentation may alternatively or additionally comprise grouping picture elements having similar colours in the same segment.

The segmentation process is in the preferred embodiment part of the detection process.

In the preferred embodiment, the T-junctions are identified by analysing all 2×2 sub-matrices of the segmentation matrix. Since the T-junctions are to be detected, the analysis focuses on 3-junctions which are junctions at which exactly three different image segments meet.

In order to extract 3-junctions from the segmentation matrix, the structure of all possible 2×2 sub-matrices is examined. A sub-matrix contains a 3-junction if exactly one of the four differences
S_{i,j}−S_{i+1,j}, S_{i,j+1}−S_{i+1,j+1}, S_{i,j}−S_{i,j+1}, S_{i+1,j}−S_{i+1,j+1}
is equal to zero. This is for example the case for the following sub-matrices:

$$[ \begin{matrix}1 & 2 \\ 1 & 3\end{matrix} ] , [ \begin{matrix}2 & 1 \\ 3 & 1\end{matrix} ] , [ \begin{matrix}1 & 1 \\ 2 & 3\end{matrix} ] , [ \begin{matrix}2 & 3 \\ 1 & 1\end{matrix} ]$$

but not for example for the following sub-matrix.

$$[ \begin{matrix}1 & 2 \\ 3 & 1\end{matrix} ]$$

This sub-matrix is not considered to be a 3-junction because region number 1, which occurs twice, is not 4-connected. This violates the basic assumption that regions in the segmentation must be 4-connected on a square sampling grid.

In other words, a 2 by 2 sub-matrix is considered a 3-junction if the four elements correspond to exactly three image segments and the two samples from the same image segments are next to each other either vertically or horizontally (but not diagonally).

It should be noted that a 3-junction is not necessarily a T-junction, but may also indicate a fork or an arrow shape (which may for example occur in the image of a cube). A further geometric analysis is therefore needed to determine whether a detected 3-junction may be considered a T-junction. However, as such a geometric analysis has already been performed to extract the object points, the remaining points meeting the above criteria may be considered T-junction points. All other points are discarded as falsely detected points.

Step 303 is followed by step 305 wherein the image points of the group of object points and the group of junction points are individually processed. In the preferred embodiment the individual processing is aimed at determining at least one three dimensional characteristic from 2D images based on object points and junction points respectively.

In the preferred embodiment, separate processes are applied to the different groups of object points. Thus, the individual processing comprises applying a first process to the group of object points and applying a second process to the group of junction points.

In the preferred embodiment, the first process is an object process which is based on object motion within the at least one image. The first process may for example be a process for determining 3D characteristics based on the movement of object points within a sequence of images. The process may for example be a dynamic occlusion process but is in the preferred embodiment a structure from motion process. Thus, a 3D model of objects in the image may be derived based on the movement of the corresponding object points.

In the preferred embodiment, the second process is an object process based on a static characteristic of the image, and is specifically a process for determining a depth characteristic of an object in the image. Thus, in the preferred embodiment object points are used to determine depth information based on dynamic characteristics whereas junction points are used for determining depth information based on static characteristics.

The second process may be a process for determining depth information in accordance with the approach described in “Filtering, Segmentation and Depth” by M. Nitzberg, D. Mumford and T. Shiota, 1991. Lecture Notes in Computer Science 662. Springer-Verlag, Berlin.

FIG. 4 illustrates an example of a T-junction in an image and illustrates how depth information may be found from a T-junction. In the illustrated example, the image comprises a first rectangle 401 and a second rectangle 403. The first rectangle 401 overlaps the second rectangle 403 and accordingly edges form an intersection known as a T-junction 405. Specifically, a first edge 407 of the second rectangle 403 is cut short by a second edge 409 of the first rectangle. Accordingly, the first edge 407 forms a stem 411 of the T-junction 405 and the second edge 409 forms a top 413 of the T-junction.

Thus, in the example the T-junction 405 is the point in the image plane where the object edges 407, 409 form a “T” with one edge 407 terminating on a second edge 409. Humans are capable of identifying that some objects are nearer than others just by the presence of T-junctions. In the example of FIG. 4, it is clear that the first rectangle 401 occludes the second rectangle 403 and thus that the object corresponding to the first rectangle 401 is in front of the object corresponding to the second rectangle 403.

Hence, by determining a top and a stem of the T junction, relative depth information between objects may be determined. Identification of the top and stem is used in deriving a possible depth order. To identify the top and the stem, it is in the preferred embodiment assumed that both are straight lines which pass through the junction point, but with an arbitrary orientation angle. Accordingly, the junction is fitted to first and second curves, which in the preferred embodiment are straight lines, and the regions forming the stem and the top are determined in response thereto.

As is clear from FIG. 4, the image section which forms the top but not the stem is inherently in front of the image sections forming the stem. Depth information between the two image sections forming the stem cannot directly be derived from the T-junction. In the preferred embodiment, many T-junctions are determined and specifically a given object may have many corresponding T-junctions. Therefore, relative depth information may be determined by considering the relative depth information of all objects and specifically a depth map representing the relative depth of objects in images may be derived.

The depth information based on the dynamic performance of the object points may be combined with the relative depth information based on the static characteristics of the T-junctions thereby enhancing and/or improving the generated depth information.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A method of object processing for at least one image comprising the steps of:
detecting (301) a plurality of image points (105, 107, 109, 111) associated with at least one object of the at least one image;
grouping (303) the plurality of image points (105, 107, 109, 111) into at least a group of object points (105, 107) and a group of junction points (111); and
individually (305) processing the image points of the group of object points (105, 107) and the group of junction points (111).

2. A method of object processing as claimed in claim 1 wherein the step (305) of individually processing comprises determining at least one three dimensional characteristic from at least one two dimensional image.

3. A method of object processing as claimed in claim 1 wherein the plurality of image points (105, 107, 109, 111) are further grouped into a group of falsely detected points (109).

4. A method of object processing as claimed in claim 3 wherein each of the plurality of image points (105, 107, 109, 111) is included in only one group selected from the group of object points (105, 107), the group of junction points (111) and the group of falsely detected points (109).

5. A method of object processing as claimed in claim 1 wherein the step (305) of individually processing comprises applying a first process to the group of object points (105, 107) and applying a second process to the group of junction points (111).

6. A method of object processing as claimed in claim 5 wherein the first process is an object process based on object motion within the at least one image.

7. A method of object processing as claimed in claim 5 wherein the first process is a structure from motion process.

8. A method of object processing as claimed in claim 5 wherein the second process is an object process based on a static characteristic within the at least one image.

9. A method of object processing as claimed in claim 5 wherein the second process is a process for determining a depth characteristic of at least one object of the at least one image.

10. A method of object processing as claimed in claim 9 wherein the depth characteristic is a relative depth characteristic indicating a relative depth between a plurality of objects of the at least one image.

11. A method of object processing as claimed in claim 1 wherein the step of detecting (301) the plurality of image points (105, 107, 109, 111) comprises applying a curvature detection process to at least a part of the at least one image.

12. A method of object processing as claimed in claim 1 wherein the junction points (111) comprise T-junction points (111) corresponding to an overlap between two objects of the at least one image.

13. A computer program enabling the carrying out of a method according to claim 1.

14. A record carrier comprising a computer program as claimed in claim 13.

15. An apparatus for object processing for at least one image comprising:
means (201) for detecting a plurality of image points (105, 107, 109, 111) associated with at least one object of the at least one image;
means (203) for grouping the plurality of image points (105, 107, 109, 111) into at least a group of object points (105, 107) and a group of junction points (111); and
means (209) for individually processing the image points of the group of object points (105, 107) and the group of junction points (111).
